(19) United States
(12) Patent Application Publication
(10) Pub. No.: US 2023/0297112 A1
(43) Pub. Date: Sep. 21, 2023

(54) INFORMATION PROCESSING METHOD, INFORMATION PROCESSING DEVICE, AND PROGRAM

(71) Applicant: MITSUBISHI HEAVY INDUSTRIES, LTD., Tokyo (JP)

(72) Inventors: Kenji TAKAO, Tokyo (JP); Atsuyoshi SAIMEN, Tokyo (JP)

(73) Assignee: MITSUBISHI HEAVY INDUSTRIES, LTD., Tokyo (JP)

(21) Appl. No.: 18/089,402

(22) Filed: Dec. 27, 2022

(30) Foreign Application Priority Data
Mar. 16, 2022 (JP) 2022-041726

(51) Int. Cl. G05D 1/02

(52) U.S. Cl. CPC G05D 1/0212; B66F 9/063

(57) ABSTRACT

An information processing method includes acquiring position information of a failed mobile body, and setting a recovery route based on the position information of the failed mobile body, the recovery route being a route leading to the failed mobile body for recovering a recovery target by a recovery mobile body, the recovery mobile body being a mobile body other than the failed mobile body.

### CROSS-REFERENCE TO RELATED APPLICATIONS

This application claims the benefit of priority to Japanese Patent Application Number 2022-041726 filed on Mar. 16, 2022. The entire contents of the above-identified application are hereby incorporated by reference.

### TECHNICAL FIELD

The disclosure relates to an information processing method, an information processing device, and a program.

### RELATED ART

There is a known technology for setting travel routes for a plurality of mobile bodies that move automatically. For example, JP 6599139 B describes an operation management method in which a basic travel route that is a shortest distance from a current position of a cargo handling vehicle to a start position of a work is set, and when the basic travel route interferes with a basic travel route of another cargo handling vehicle, the basic travel route of the vehicle having a higher priority is adopted and a detour route is set for the vehicle having a lower priority.

### SUMMARY

However, there may be a case where a failure occurs in a mobile body during actual movement of the mobile bodies and thus the movement along scheduled routes cannot be appropriately executed. In such a case, for example, it is conceivable that after all the mobile bodies are stopped, the failed mobile body is manually recovered and then the movement is resumed. However, when such measures are taken, it takes time to complete the movement of the mobile bodies, and if there is no operator for recovery, it needs more time, and thus an operating ratio is reduced. Therefore, there is a need for suppressing a reduction in the operating ratio of the mobile body.

The disclosure has been made to solve the above-described problem, and an object of the disclosure is to provide an information processing method, an information processing device, and a program that can suppress the reduction in the operating ratio of a mobile body.

An information processing method according to the disclosure includes a step of acquiring position information of a failed mobile body, and a step of setting a recovery route based on the position information of the failed mobile body, the recovery route being a route leading to the failed mobile body for recovering a recovery target by a recovery mobile body, the recovery mobile body being a mobile body other than the failed mobile body.

An information processing device according to the disclosure includes a position information acquisition unit configured to acquire position information of a failed mobile body, and a work setting unit configured to set a recovery route based on the position information of the failed mobile body, the recovery route being a route leading to the failed mobile body for recovering a recovery target by a recovery mobile body, the recovery mobile body being a mobile body other than the failed mobile body.

A program according to the disclosure causes a computer to perform processing, the processing including acquiring position information of a failed mobile body, and setting a recovery route based on the position information of the failed mobile body, the recovery route being a route leading to the failed mobile body for recovering a recovery target by a recovery mobile body, the recovery mobile body being a mobile body other than the failed mobile body.

According to the disclosure, the reduction in the operating ratio of a mobile body can be suppressed.

### BRIEF DESCRIPTION OF DRAWINGS

The disclosure will be described with reference to the accompanying drawings, wherein like numbers reference like elements.

FIG. 1 is a schematic view of a movement control system according to the present embodiment.

FIG. 2 is a schematic view of a configuration of a mobile body.

FIG. 3 is a schematic block diagram of a management device.

FIG. 4 is a schematic block diagram of an information processing device.

FIG. 5 is a schematic block diagram of a control device for the mobile body.

FIG. 6 is a table showing an example of movement destination information.

FIG. 7 is a table for explaining the setting of a work.

FIG. 8 is a schematic view illustrating a process of recovering a target object by another mobile body.

FIG. 9 is a flowchart illustrating a processing flow for recovering a recovery target.

FIG. 10 is a schematic view illustrating a process of recovering a failed mobile body by another mobile body.

### DESCRIPTION OF EMBODIMENTS

Hereinafter, preferred embodiments of the disclosure will be described in detail with reference to the accompanying drawings. Note that the disclosure is not limited to these embodiments, and when there are a plurality of embodiments, the disclosure is intended to include a configuration combining these embodiments.

### First Embodiment

### Movement Control System

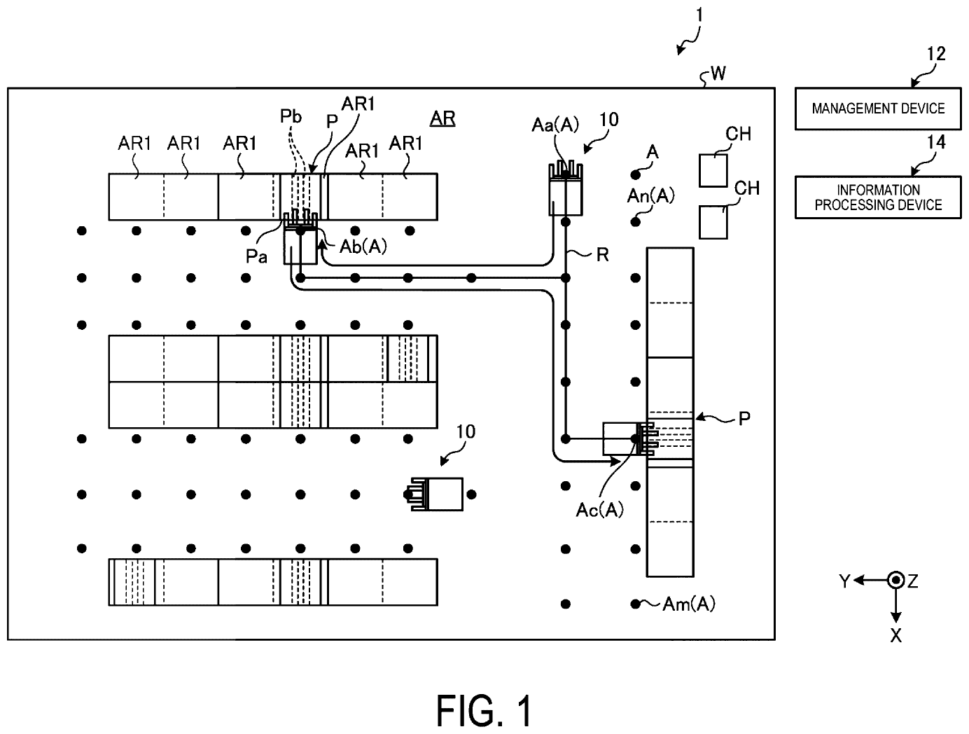

FIG. 1 is a schematic view of a movement control system according to the present embodiment. As illustrated in FIG. 1, a movement control system 1 according to the present embodiment includes a mobile body 10, a management device 12, and an information processing device 14. The movement control system 1 is a system that controls the movement of the mobile body 10 belonging to a facility W. The facility W is a facility, such as a warehouse, that is logistically managed. The movement control system 1 causes the mobile body 10 to pick up and convey a target object P disposed within an area AR in the facility W. The area AR is, for example, a floor surface of the facility W, and is an area in which the target object P is placed and through which the mobile body 10 moves. In the present embodiment, the target object P is a conveyance target object composed of a pallet and a burden loaded on the pallet. The target object P includes an opening Pb into which a fork 24 of the mobile body 10 to be described later is inserted, and the opening Pb is formed in a front surface Pa of the target object P. However, the target object P is not limited to an object composed of a pallet and a burden loaded on the pallet, and may be only a burden without a pallet, for example.

Hereinafter, an operation including movement along a route R (to be described later) by the mobile body 10 will be appropriately referred to as a work of the mobile body 10. Further, in the present embodiment, the mobile body 10 moves along the route R to load, convey, and unload the target object P, and thus a series of operations by the mobile body 10 to move along the route R, and load, convey, and unload the target object P can be said to be the work of the mobile body 10. Hereinafter, one direction along the area AR is referred to as an X direction, and a direction along the area AR that is orthogonal to the X direction is referred to as a Y direction. In the present embodiment, the Y direction is a direction orthogonal to the X direction. The X direction and the Y direction may be horizontal directions. A direction orthogonal to the X direction and the Y direction, more specifically, an upward direction in the vertical direction is referred to as a Z direction. In the present embodiment, unless otherwise specified, a “position” refers to a position (coordinates) in a coordinate system in a two dimensional plane on the area AR (the coordinate system of the area AR). Also, unless otherwise specified, an “orientation” of the mobile body 10 or the like refers to an orientation of the mobile body 10 in the coordinate system of the area AR, and means a yaw angle (rotation angle) of the mobile body 10 with the X direction defined as 0 degrees when viewed from the Z direction.

A plurality of placement areas AR1 is disposed in the area AR in the facility W. The placement areas AR1 are configured to be used as areas in which the target object P is placed. The target object P may be placed or may not be placed in each placement area AR1 depending on the situation of the facility W. The position (coordinates), the shape, and the size of the placement area AR1 are determined in advance. In the example illustrated in FIG. 1, the placement areas AR1 are set on a shelf provided in the area AR, but are not limited thereto, and may be provided on the area AR (i.e., on the floor of the facility W), or may be provided in a loading platform of a vehicle that has conveyed the target object P into the facility W. In addition, in the present embodiment, the placement area AR1 is defined for each target object P, and one target object P is placed in each placement area AR1, but the disclosure is not limited thereto. For example, the placement area AR1 may be set as a free space in which a plurality of target objects P are placed. In addition, in the example in FIG. 1, the placement area AR1 has a rectangular shape, but may have any shape and any size, and the number of the placement areas AR1 is also optional.

### Waypoint

In the area AR, a waypoint A is set for each position (coordinates). The route R along which the mobile body 10 moves is configured to connect the waypoints A. That is, a route connecting the waypoints A through which the mobile body 10 is scheduled to pass is the route R of the mobile body 10. The waypoints A are set according to the layout of the facility W such as the positions of the placement areas AR1 and passages. For example, the waypoints A are set in a matrix form in the area AR, and the positions and the number of the waypoints A are set such that a route R connecting a position facing one placement area AR1 to a position facing another arbitrary placement area AR1 can be set. The position facing the placement area AR1 may be, for example, a position at which the mobile body 10 can pick up the target object P placed in the placement area AR1. In addition, the waypoints A include a waypoint A configured to be a charging point (in the example of FIG. 1, a waypoint An at which a charger CH is placed) or a waypoint A configured to be a waiting point (in the example of FIG. 1, a waypoint Am). The waypoint A that is a charging point or a waiting point may be set at any position that does not overlap with a route (the route used for conveyance) connecting the waypoints A facing the respective placement areas AR1.

### Mobile Body

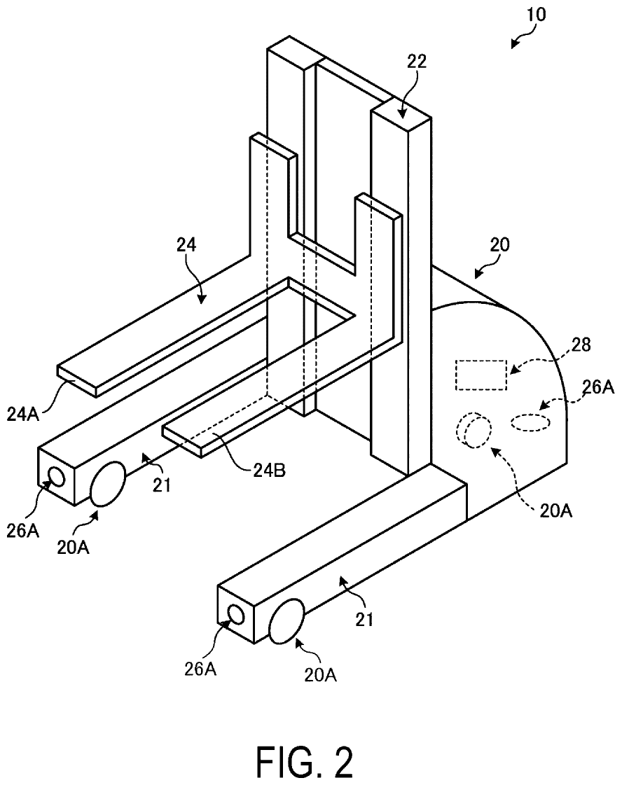

FIG. 2 is a schematic view of a configuration of a mobile body. The mobile body 10 is a device that can move automatically and convey the target object P. Further, in the present embodiment, the mobile body 10 is a forklift, and more specifically, a so-called automated guided vehicle (AGV) or a so-called automated guided forklift (AGF). However, the mobile body 10 is not limited to a forklift for conveying the target object P, and may be any device capable of moving automatically.

As illustrated in FIG. 2, the mobile body 10 includes a vehicle body 20, a wheel 20A, a straddle leg 21, a mast 22, a fork 24, a sensor 26A, and a control device 28. The straddle leg 21 is a shaft-like member that is disposed in pairs at one end portion of the vehicle body 20 in a front-back direction and protrudes from the vehicle body 20. The wheel 20A is disposed at a leading end of each of the straddle legs 21 and at the vehicle body 20. That is, a total of three wheels 20A are disposed, but the positions and the number of the wheels 20A disposed may be arbitrary. The mast 22 is movably attached to the straddle legs 21 and moves in the front-back direction of the vehicle body 20. The mast 22 extends along the vertical direction (here, the direction Z) orthogonal to the front-back direction. The fork 24 is attached to the mast 22 so as to be movable in the direction Z. The fork 24 may be movable in a lateral direction of the vehicle body 20 (a direction intersecting with the vertical direction and the front-back direction) with respect to the mast 22. The fork 24 includes a pair of tines 24A and 24B. The tines 24A and 24B extend, from the mast 22, toward the front direction of the vehicle body 20. The tines 24A and 24B are arranged separated from each other in the lateral direction of the mast 22. In the front-back direction, a direction to a side of the mobile body 10 where the fork 24 is disposed and a direction to a side where the fork 24 is not disposed are referred to as a front direction and a back direction, respectively.

The sensors 26A detect at least one of the position and the orientation of a target object present in the periphery of the vehicle body 20. That is, it can be said that the sensor 26A detects at least one of the position of the target object relative to the mobile body 10 and the orientation of the target object relative to the mobile body 10. In the present embodiment, the sensor 26A is disposed at a leading end of each of the straddle legs 21 in the front direction, and at the vehicle body 20 on a back direction side. However, the positions at which the sensors 26A are disposed are not limited thereto, and the sensors 26A may be disposed at any positions, and the number of the sensors 26A disposed may be arbitrary.

The sensor 26A is a sensor that emits a laser beam, for example. The sensor 26A emits the laser beam while performing scanning in one direction (here, the lateral direction), and detects the position and the orientation of the target object based on the reflected light of the laser beam emitted. That is, the sensor 26A is a so-called two-dimensional (2D) light detection and ranging (LiDAR) sensor. Note that the sensor 26A is not limited to the one described above and may be a sensor that detects the target object using any method, such as a so-called three-dimensional (3D)-LiDAR in which scanning is performed in multiple directions, or may be a so-called one dimensional (1D)-LiDAR in which no scanning is performed, or may be a camera.

The control device 28 controls the movement of the mobile body 10. The control device 28 will be described later.

### Management Device

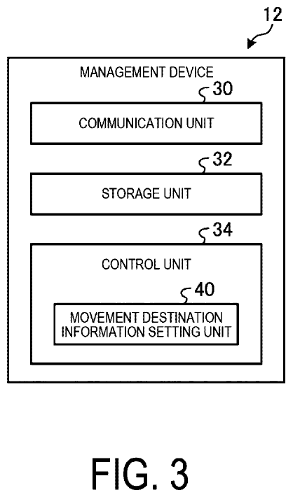

FIG. 3 is a schematic block diagram of a management device. The management device 12 is a system that manages physical distribution in the facility W. The management device 12 is a warehouse control system (WCS) or a warehouse management system (WMS) in the present embodiment, but is not limited to a WCS and a WMS, and may be any system including a backend system such as any other production management system. The management device 12 may be disposed at any position, and may be disposed in the facility W, or may be disposed at a separate position from the facility W so as to manage the facility W from the separate position. The management device 12 is a computer and includes a communication unit 30, a storage unit 32, and a control unit 34 as illustrated in FIG. 3.

The communication unit 30 is a module used by the control unit 34 to communicate with an external device such as the information processing device 14, and may include, for example, a Wi-Fi (registered trademark) module or an antenna. The communication method of the communication unit 30 is wireless communication in the present embodiment, but any communication method may be used. The storage unit 32 is a memory that stores various information such as computation contents of the control unit 34 and programs, and includes, for example, at least one of a primary storage device such as a random access memory (RAM) or a read only memory (ROM), and an external storage device such as a hard disk drive (HDD).

The control unit 34 is an arithmetic device and includes, for example, an arithmetic circuit such as a central processing unit (CPU). The control unit 34 includes a movement destination information setting unit 40. The control unit 34 reads a program (software) from the storage unit 32 and executes the program to implement the movement destination information setting unit 40 and perform the processing thereof. Note that the control unit 34 may execute such processing with a single CPU, or may include a plurality of CPUs and execute the processing with the plurality of CPUs. The movement destination information setting unit 40 may be implemented by a hardware circuit. The program for the control unit 34 stored in the storage unit 32 may be stored in a recording medium that is readable by the management device 12.

The movement destination information setting unit 40 sets movement destination information indicating a movement destination of the mobile body 10. The processing by the movement destination information setting unit 40 will be more specifically described later.

Note that the management device 12 may execute processing other than the setting of the movement destination information. For example, the management device 12 may also set information for controlling a mechanism other than the mobile body 10 disposed in the facility W (for example, an elevator and a door).

### Information Processing Device

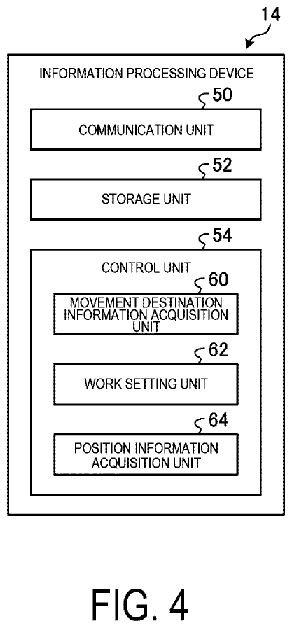

FIG. 4 is a schematic block diagram of the information processing device. The information processing device 14 is a device that is disposed in the facility W and processes information related to the movement of the mobile body 10. The information processing device 14 is, for example, a fleet control system (FCS), but is not limited thereto, and may be any device that processes information related to the movement of the mobile body 10. The information processing device 14 is a computer and includes a communication unit 50, a storage unit 52, and a control unit 54 as illustrated in FIG. 4. The communication unit 50 is a module used by the control unit 54 to communicate with an external device such as the management device 12 and the mobile body 10, and may include, for example, an antenna or a WiFi module. The communication method of the communication unit 50 is wireless communication in the present embodiment, but any communication method may be used. The storage unit 52 is a memory for storing various information such as computation contents of the control unit 54 and programs, and includes, for example, at least one of a primary storage device such as a RAM or a ROM, and an external storage device such as an HDD.

The control unit 54 is an arithmetic device and includes an arithmetic circuit such as a CPU, for example. The control unit 54 includes a movement destination information acquisition unit 60, a work setting unit 62, and a position information acquisition unit 64. The control unit 54 reads a program (software) from the storage unit 52 and executes the program to implement the movement destination information acquisition unit 60, the work setting unit 62, and the position information acquisition unit 64 and perform the processing thereof. Note that the control unit 54 may execute such processing with a single CPU or may include a plurality of CPUs and execute the processing with the plurality of CPUs. At least a part of the movement destination information acquisition unit 60, the work setting unit 62, and the position information acquisition unit 64 may be implemented by a hardware circuit. The program for the control unit 54 stored in the storage unit 52 may be stored in a recording medium that is readable by the information processing device 14.

The movement destination information acquisition unit 60 acquires the movement destination information, the work setting unit 62 sets the route R for the mobile body 10, and the position information acquisition unit 64 acquires the position information of the mobile body 10. Specific contents of the above-described processing will be described later.

Note that, in the present embodiment, the management device 12 and the information processing device 14 are separate devices, but may be an integrated device. That is, the management device 12 may have at least a part of the function of the information processing device 14, and the information processing device 14 may have at least a part of the function of the management device 12.

### Control Device for Mobile Body

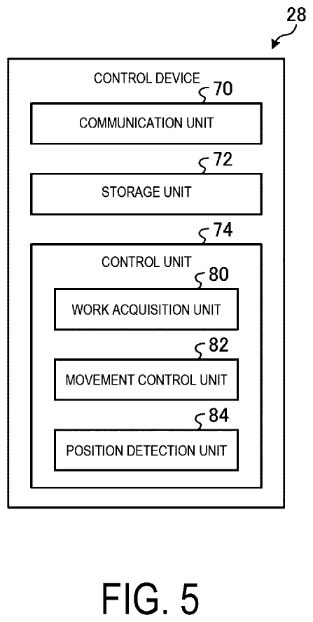

Next, the control device 28 for the mobile body 10 will be described. FIG. 5 is a schematic block diagram of a control device for the mobile body. The control device 28 is a device for controlling the mobile body 10. The control device 28 is a computer and includes a communication unit 70, a storage unit 72, and a control unit 74 as illustrated in FIG. 5. The communication unit 70 is a module used by the control unit 74 to communicate with an external device such as the information processing device 14, and may include, for example, an antenna or a WiFi module. The communication method of the communication unit 70 is wireless communication in the present embodiment, but any communication method may be used. The storage unit 72 is a memory for storing various information such as computation contents of the control unit 74 and programs, and includes, for example, at least one of a primary storage device such as a RAM or a ROM, and an external storage device such as an HDD.

The control unit 74 is an arithmetic device and includes an arithmetic circuit such as a CPU, for example. The control unit 74 includes a work acquisition unit 80, a movement control unit 82, and a position detection unit 84. The control unit 74 reads a program (software) from the storage unit 72 and executes the program to implement the work acquisition unit 80, the movement control unit 82, and the position detection unit 84 and perform the processing thereof. Note that the control unit 74 may execute such processing with a single CPU or may include a plurality of CPUs and execute the processing with the plurality of CPUs. At least a part of the work acquisition unit 80, the movement control unit 82, and the position detection unit 84 may be implemented by a hardware circuit. In addition, the program for the control unit 74 stored in the storage unit 72 may be stored in a recording medium that is readable by the control device 28.

The work acquisition unit 80 acquires information indicating the route R of the mobile body 10, the movement control unit 82 controls a movement mechanism such as a drive unit or a steering device of the mobile body 10 so as to control the movement of the mobile body 10. The position detection unit 84 detects the position of the mobile body 10. Specific contents of the above-described processing will be described later.

### Processing of Movement Control System

Next, the processing contents of the movement control system 1 will be described.

### Setting of Movement Destination Information

The movement destination information setting unit 40 of the management device 12 sets movement destination information indicating a movement destination of the mobile body 10. The movement destination information includes information indicating the position of the movement destination of the mobile body 10. More specifically, in the present embodiment, the movement destination information setting unit 40 sets the movement destination information so as to include first position information (position information of a first position) and second position information (position information of a second position). The first position is a position which the mobile body 10 reaches first, and the second position is a position which the mobile body 10 reaches next to the first position. That is, in the example of the present embodiment, the first position is the position of a conveyance source of the target object P, and the second position is the position of a conveyance destination of the target object P. The movement destination information setting unit 40 may directly specify the position (coordinates) of the first position as the first position information. In addition, an identifier may be assigned to each waypoint A, and the movement destination information setting unit 40 may specify the identifier of a waypoint A corresponding to the first position as the first position information. The same applies to the second position information.

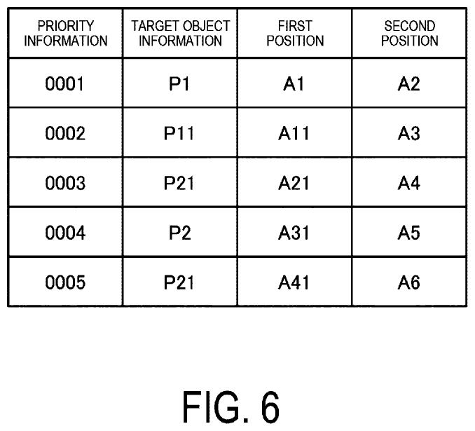

FIG. 6 is a table showing an example of movement destination information. In the present embodiment, the movement destination information setting unit 40 sets the movement destination information for each target object P to be conveyed, in other words, for each work. That is, the movement destination information setting unit 40 associates target object information indicating a target object P to be conveyed, the first position information that is the conveyance source of the target object P, and the second position information indicating the conveyance destination of the target object P with each other so as to set the movement destination information for each target object P. Note that, for example, an identifier may be assigned to each target object P, and information indicating the identifier may be used as the target object information. Further, as illustrated in FIG. 6, in the present embodiment, it is preferable for the movement destination information setting unit 40 to associate the target object information, the first position information, the second position information, and priority information with each other so as to set the movement destination information for each target object P. The priority information is information indicating a priority order for conveying a target object P among a group of movement destination information for each target object P. That is, for example, a target object P having the highest priority in the priority information is to be conveyed first. FIG. 6 shows an example in which pieces of movement destination information are set as follows: movement destination information in which the priority is 0001 (first), the target object is P1, the first position is A1, and the second position is A2; movement destination information in which the priority is 0002 (second), the target object is P11, the first position is A11, and the second position is A3; movement destination information in which the priority is 0003 (third), the target object is P21, the first position is A21, and the second position is A4; movement destination information in which the priority is 0004 (fourth), the target object is P2, the first position is A31, and the second position is A5; and movement destination information in which the priority is 0005 (fifth), the target object is P21, the first position is A41, and the second position is A6. However, FIG. 6 is only an example, and the movement destination information may be arbitrarily set in accordance with an order status or the like.

In addition, the movement destination information setting unit 40 may set the movement destination information so as to include designation information for designating a mobile body 10 to move from the first position to the second position (a mobile body 10 to perform the work). That is, in the example of the present embodiment, the movement destination information setting unit 40 may associate the target object information, the first position information, the second position information, the priority information, and the designation information with each other so as to set the movement destination information for each target object P. In that case, for example, an identifier may be assigned to each mobile body 10, and information indicating the identifier may be used as the designation information.

The movement destination information setting unit 40 may set the movement destination information in any method. For example, the movement destination information setting unit 40 may acquire an order information indicating a target object P to be conveyed, a conveyance source, and a conveyance destination, and set the movement destination information based on the order information. The movement destination information setting unit 40 transmits the set movement destination information to the information processing device 14 via the communication unit 30.

### Acquisition of Movement Destination Information

The movement destination information acquisition unit 60 of the information processing device 14 acquires the movement destination information from the management device 12 via the communication unit 50.

### Setting of Work

The work setting unit 62 of the information processing device 14 sets a work of the mobile body 10 based on the movement destination information. The work setting unit 62 sets the route R of the mobile body 10 to the movement destination as the work of the mobile body 10. In the present embodiment, the work setting unit 62 sets, as the route R of the mobile body 10, a first route to the first position (conveyance source) indicated by the first position information from an initial position at which the mobile body 10 is located immediately before starting to move to the first position, and a second route to the second position (conveyance destination) indicated by the second position information from the first position. That is, the work setting unit 62 sets the route R of the mobile body 10 such that respective waypoints A from the initial position to the first position are set as the first route, and respective waypoints A from the first position to the second position are set as the second route. In the example of FIG. 1, the movement destination information indicates that the first position is a waypoint Ab and the second position is a waypoint Ac, and the work setting unit 62 sets, as the route R of the mobile body 10, the first route passing through respective waypoints A from the waypoint Aa, which is the initial position of the mobile body 10 selected, to the waypoint Ab, and the second route passing through respective waypoints A from the waypoint Ab to the waypoint Ac.

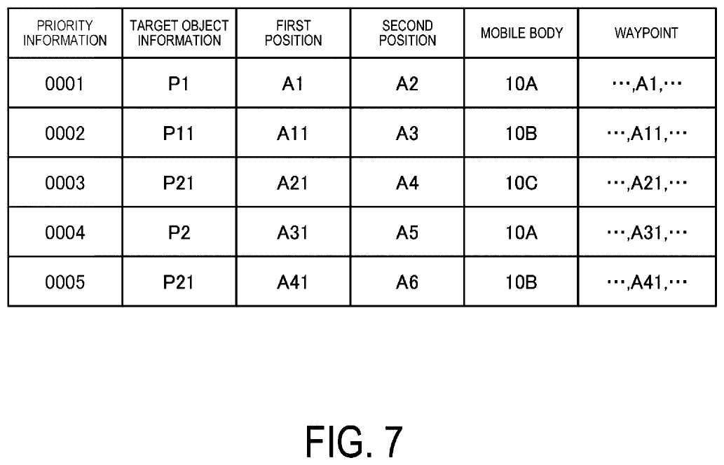

FIG. 7 is a table for explaining the setting of the work. When a plurality of mobile bodies 10 are deployed in the facility W, the work setting unit 62 selects a mobile body 10 that conveys a target object P as the work of the mobile body 10. Also, when the movement destination information is set for a plurality of target objects P, the work setting unit 62 sets the route R of a mobile body 10 for each target object P. That is, the work setting unit 62 selects, for each target object P, a mobile body 10 that conveys the target object P, and sets the route of the selected mobile body 10. In the example of FIG. 7, the work setting unit 62 selects a mobile body 10A as the mobile body 10 that conveys a target object P1 indicated by the movement destination information, and sets a route from the initial position of the mobile body 10A, through A1 as the first position, to A2 as the second position ( . . . waypoint A1 . . . ). Descriptions of mobile bodies selected for other target objects P illustrated in FIG. 7 and the routes (waypoints) thereof are the same as those above, and thus are omitted. Note that the work setting unit 62 may select a mobile body 10 in any manner, and may select a mobile body 10 for each target object P such that the time until the completion of the conveyance of all the target objects P is the shortest, for example. In the case where a target mobile body 10 has been designated as the designation information in the movement destination information, it is only necessary to select the mobile body 10 designated in the designation information.

The work setting unit 62 also sets a reserved time period during which the selected mobile body 10 passes through the route R (waypoints A) as the work of the mobile body 10. In this case, other mobile bodies 10 are prohibited from passing through the route R during the reserved time period. That is, the selected mobile body 10 occupies the set route R during the reserved time period. In setting the route R for each of a plurality of target objects P, the work setting unit 62 sets a mobile body 10, a route R (waypoints A), and a reserved time period for each target object P such that, in the reserved time period of one mobile body 10, the same waypoints A as those for the one mobile body 10 are not set for other mobile bodies (such that there is no overlapping of reserved time periods) and such that no deadlock occurs even when there is no overlapping of reserved time periods. Further, the work setting unit 62 may set a route R and a reserved time period also based on the priority information in the movement destination information. That is, the work setting unit 62 sets a mobile body 10, a route R, and a reserved time period for each target object P such that there is no overlapping of reserved time periods and that the conveyance of a target object P having a higher priority is completed sooner. Note that the route R includes a plurality of waypoints A, and thus the work setting unit 62 may set a reserved time period for each waypoint A included in the route R.

Note that the deadlock refers to a phenomenon in which each of a plurality of running programs or the like mutually waits for a result of other programs, and remains in a standby state and does not operate. In the present embodiment, the deadlock may refer to a phenomenon in which the mobile bodies 10 remain stopped if there is a possibility that the mobile bodies 10 will collide with each other when the mobile bodies 10 keep moving along the current routes, and if it is impossible to set avoidance routes toward travel direction sides.

The work setting unit 62 transmits information on the set work to the mobile body 10 to which the set work is assigned. In the example of FIG. 7, the work setting unit 62 transmits information on the work for the target object P1 and information on the work for the target object P2 to the mobile body 10A. The work setting unit 62 transmits information on the route R as the information on the work. The work setting unit 62 transmits information indicating respective waypoints A through which the route R passes as the information on the route R. For example, the work setting unit 62 may transmit position (coordinate) information of respective waypoints A through which the route R passes to the mobile body 10 as the information on the route R, or may transmit information indicating the identifiers of respective waypoints A through which the route R passes to the mobile body 10 as the information on the route R. Further, in the present embodiment, the work setting unit 62 also transmits information on the reserved time period, that is, information indicating the reserved time period during which the mobile body 10 passes through the route (waypoints A) to the mobile body 10 as the information on the work.

### Movement of Mobile Body

The work acquisition unit 80 of a mobile body 10 acquires information on the route R set for the mobile body 10 from the information processing device 14. The movement control unit 82 of the mobile body 10 moves the mobile body 10 along the route R acquired. In the present embodiment, the work acquisition unit 80 also acquires information on the reserved time period together with the information on the route R. The movement control unit 82 causes the mobile body 10 to pass through each waypoint A through which the route R passes during the reserved time period set for each waypoint A. The movement control unit 82 causes the mobile body 10 to move so as to pass through each waypoint A on the route R by sequentially grasping the position information of the mobile body 10 through the position detection unit 84. The method of acquiring the position information of the mobile body 10 by the position detection unit 84 is arbitrary. In the present embodiment, for example, a detection body (not illustrated) is disposed in the facility W, and the position detection unit 84 acquires the information on the position and the orientation of the mobile body 10 based on the detection of the detection body. Specifically, the mobile body 10 irradiates the detection body with a laser beam, receives light of the laser beam reflected from the detection body, and detects the position and the orientation of the mobile body 10 in the facility W. The method of acquiring the information on the position and the orientation of the mobile body 10 is not limited to using a detection body, and simultaneous localization and mapping (SLAM) may be used, for example. In this case, the position information acquisition unit 64 of the information processing device 14 may sequentially acquire the position information of the mobile body 10 detected by the position detection unit 84 from the mobile body 10.

In the example of FIG. 1, the movement control unit 82 causes the mobile body 10 to move from the waypoint Aa, which is the initial position, to the waypoint Ab, which is the first position, so as to pass through each waypoint A from the waypoint Aa to the waypoint Ab. When the mobile body reaches the waypoint Ab, the movement control unit 82 controls the fork 24 to insert the fork 24 into the opening Pb of the target object P placed in the placement area AR1 facing the waypoint Ab so as to pick up (load) the target object P. In this case, the movement control unit 82 may cause the sensor 26A to detect the position and the orientation of the target object P at the waypoint Ab or at any position before reaching the waypoint Ab. Then, the movement control unit 82 may set an approach route to the target object P based on the position and the orientation of the target object P, and approach the target object P along the approach route to pick up the target object P. That is, in that case, the movement control unit 82 may set a new approach route that allows a predetermined position and a predetermined orientation with respect to the position and the orientation of the target object P detected (the position and the orientation at which the mobile body 10 can pick up the target object P), and approach the target object P along the approach route. Alternatively, for example, the movement control unit 82 may cause the mobile body 10 to approach the target object P by performing feedback control (direct feedback control) based on the detection result of the position and the orientation of the target object P and the detection result of the position and the orientation of the mobile body 10. In that case, switching to the direct feedback control may be performed during the approach along a route based on the position and the orientation of the target object P.

After the mobile body 10 picks up the target object P, the movement control unit 82 causes the mobile body 10 to return to the waypoint Ab and then move to the waypoint Ac, which is the second position, so as to pass through each waypoint A from the waypoint Ab to the waypoint Ac. When the mobile body 10 reaches the waypoint Ac, the movement control unit 82 controls the fork 24 to drop (unload) the target object P in the placement area AR1 facing the waypoint Ac.

After the mobile body 10 drops the target object P, the movement control unit 82 causes the mobile body 10 to return to the waypoint Ac. When a next route R in which the waypoint Ac is the initial position has already been set, the movement control unit 82 causes the mobile body 10 to move along that route R.

### Failure of Mobile Body

Here, when the mobile body 10 fails, the work cannot be continued, and the operating ratio of the mobile body 10 is reduced. In contrast, in the present embodiment, the reduction in the operating ratio is suppressed by recovering a recovery target by another mobile body 10. Further, in the present embodiment, another mobile body 10 recovers a target object P conveyed by the mobile body that has failed and conveys the target object P as substitute for the mobile body 10 that has failed. In the detailed description below, the mobile body 10 that has failed is referred to as a mobile body 10A, and the mobile body 10 that recovers a recovery target is referred to as a mobile body 10B (recovery mobile body). Note that, in the present embodiment, the mobile body 10B for recovering the recovery target may be arbitrarily designated. For example, the mobile body 10B dedicated for the recovery of the recovery target may be set, or a mobile body 10 for conveying a target object P may be designated as the mobile body 10B.

### Occurrence of Failure

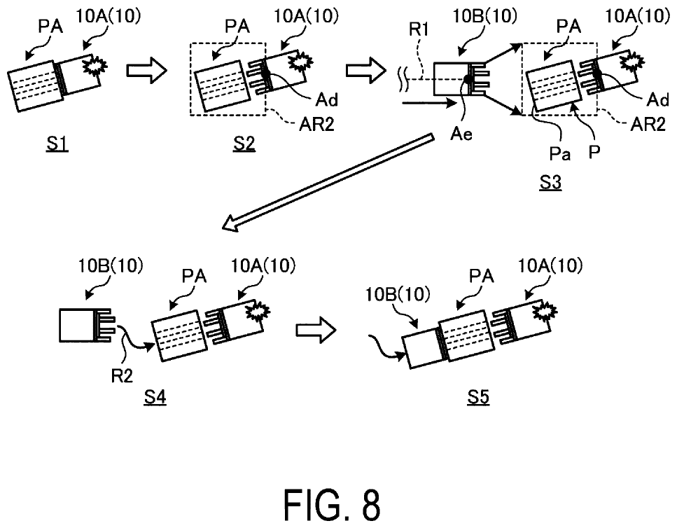

FIG. 8 is a schematic view illustrating a process of recovering a target object by another mobile body. In the following, an example will be described in which a failure occurs in the mobile body 10A conveying a target object PA as illustrated in step S1 of FIG. 8. Here, the failure refers to an event in which the mobile body 10A is unable to move. For example, when a drive system of the mobile body 10A fails, or when the mobile body 10A cannot detect a self-position (position information of the mobile body 10A), the mobile body 10A becomes unable to move. Further, in the present embodiment, the mobile body 10A that has failed cannot move, but can drop the target object PA. That is, in the mobile body 10A, the mast 22, the fork 24, and the like can be operated, and the movement control unit 82 can control these components so as to drop the target object PA. Thus, in the present embodiment, as illustrated in step S2 of FIG. 8, when the mobile body 10A cannot move due to the failure, the movement control unit 82 of the mobile body 10A drives the mast 22, the fork 24, and the like to drop the target object PA at the position where the mobile body 10A is stopped.

### Acquisition of Position Information

The position information acquisition unit 64 of the information processing device 14 acquires the position information of the mobile body 10A that has failed. The position information acquisition unit 64 acquires information on the position where the mobile body 10A is stopped due to the failure as the position information of the mobile body 10A. The position information acquisition unit 64 may acquire the position information of the mobile body 10A in any manner. For example, when the mobile body 10A can detect a self-position by the position detection unit 84, the position information acquisition unit 64 may acquire the position information on the position of the mobile body 10A kept in stopped state due to the failure detected by the position detection unit 84 as the position information of the mobile body 10A. In addition, for example, when detection of a self-position by the position detection unit 84 is not possible, the position information acquisition unit 64 may acquire the position information on the position of the mobile body 10A last detected by the position detection unit 84 as the position information of the mobile body 10A. As illustrated in step S2 in the example of FIG. 8, the position information acquisition unit 64 acquires the information of a position Ad of the mobile body 10A stopped due to the failure.

### Setting of Area of Interest

The position information acquisition unit 64 of the information processing device 14 acquires the position information of an area of interest AR2. The area of interest AR2 is an area in which a recovery target (target object PA in the present embodiment) of the mobile body 10B is expected to be present. The position information acquisition unit 64 may set the position information of the area of interest AR2 based on, for example, the position information of the mobile body 10A. In addition, for example, the position detection unit 84 of the mobile body 10A may set the position information of the area of interest AR2 based on the position information of the mobile body 10A. In that case, the position information acquisition unit 64 acquires the position information of the area of interest AR2 from the mobile body 10A. The method of setting the area of interest AR2 based on the position information of the mobile body 10A may be arbitrary. For example, an area occupying a predetermined area located at a predetermined position with respect to the position of the mobile body 10A may be set as the area of interest AR2. Note that the process of setting the area of interest AR2 is not necessary.

### Setting of Recovery Route

The work setting unit 62 of the information processing device 14 sets a recovery route R1 for recovering the recovery target (target object PA) by the mobile body 10B based on the position information of the mobile body 10A that has failed. The recovery route R1 is a route leading to the mobile body 10A, but is not limited to a route exactly reaching the position Ad of the mobile body 10A, and may be a route reaching a predetermined position Ae near the position Ad of the mobile body 10A. The predetermined position Ae here is a position (waypoint) within a predetermined range from the position Ad of the mobile body 10A, but is not limited thereto, and may be the position Ad of the mobile body 10A. Further, in the first embodiment, the predetermined position Ae is preferably a position on a side on which the target object PA is held with respect to the position Ad of the mobile body 10A (front side of the mobile body 10A on which the fork 24 is disposed) so that the target object PA can be recovered.

Specifically, the work setting unit 62 sets a first route from the initial position of the mobile body 10B (the position of the mobile body 10B immediately before starting to move along the recovery route R1) to the predetermined position Ae, and a second route from the predetermined position Ae to the second position of the target object PA as the recovery route R1. The work setting unit 62 transmits information on the set recovery route R1 to the mobile body 10B. In the present embodiment, the work setting unit 62 also transmits information on the area of interest AR2 together with the information on the set recovery route R1 to the mobile body 10B.

### Recovery of Recovery Target

As illustrated in step S3 of FIG. 8, upon acquisition of the information on the recovery route R1, the movement control unit 82 causes the mobile body 10B to move along the recovery route R1 toward the mobile body 10A. When the mobile body 10B reaches within a predetermined distance range from the mobile body 10A (the predetermined position Ae in the present embodiment), the movement control unit 82 causes the sensor 26A to detect the position and the orientation of the recovery target (the target object PA in the present embodiment). In the present embodiment, when the mobile body 10B reaches within the predetermined distance range from the mobile body 10A, the movement control unit 82 causes the sensor 26A to detect the area of interest AR2, that is, causes the sensor 26A to detect the area of interest AR2 as a detection area so as to detect the position and the orientation of the target object PA. Then, as illustrated in step S4 of FIG. 8, the movement control unit 82 sets an approach route R2 to the target object PA based on the position and the orientation of the target object PA detected. The movement control unit 82 sets the approach route R2 that allows a predetermined position and a predetermined orientation with respect to the position and the orientation of the target object PA detected (the position and the orientation at which the mobile body 10B can pick up the target object PA). Note that, in the example of FIG. 8, the target object PA is detected at the predetermined position Ae that is the arrival point of the first route of the recovery route R1, and a route from the predetermined position Ae to the target object PA is set as an approach route, but the present embodiment is not limited thereto. For example, the movement control unit 82 may detect the target object PA at any position on the recovery route R1 before reaching the predetermined position Ae, and set a route from the detection position to the target object PA as the approach route R2.

As illustrated in step S5 of FIG. 8, the movement control unit 82 causes the mobile body 10B to move along the approach route R2 so as to approach the target object PA and pick up the target object PA. Alternatively, for example, the movement control unit 82 may cause the mobile body 10B to approach the target object PA by performing feedback control (direct feedback control) based on the detection result of the position and the orientation of the target object PA and the detection result of the position and the orientation of the mobile body 10B. In that case, switching to the direct feedback control may be performed during the movement along the approach route.

After the mobile body 10B picks up the target object PA, the movement control unit 82 causes the mobile body 10B to return to the start position of the approach route R2 (the predetermined position Ae in the example of FIG. 8) and then move from the predetermined position Ae to the second position of the target object PA. When the mobile body 10B reaches the second position, the movement control unit 82 controls the fork 24 to drop the target object PA in the placement area AR1 facing the second position.

### Processing Flow

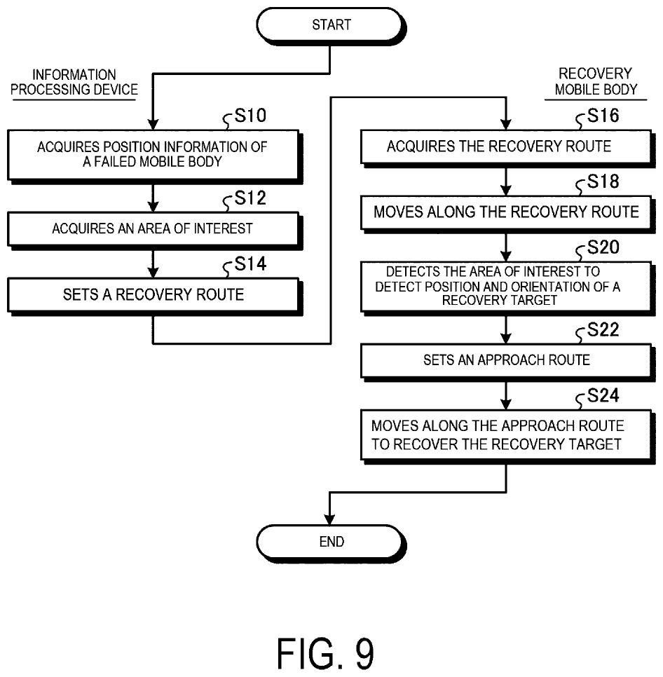

The above-described processing flow for recovering a recovery target will be described below with reference to a flowchart. FIG. 9 is a flowchart illustrating the processing flow for recovering a recovery target. As illustrated in FIG. 9, the information processing device 14 causes the position information acquisition unit 64 to acquire the position information of the mobile body 10A that has failed (step S10) and acquire the information on the area of interest AR2 (step S12), and causes the work setting unit 62 to set the recovery route R1 for the mobile body 10B based on the position information of the mobile body 10A (step S14). The mobile body 10B (recovery mobile body) acquires the information on the recovery route R1 from the information processing device 14 (step S16), and then the movement control unit 82 causes the mobile body 10B to move along the recovery route R1 (step S18). After reaching within a predetermined distance range from the mobile body 10A, the mobile body 10B causes the sensor 26A to detect the area of interest AR2 so as to detect the position and the orientation of the recovery target (the target object PA in the present embodiment) (step S20). The mobile body 10B sets the approach route R2 to the target object PA based on the position and the orientation of the target object PA (step S22), moves along the approach route R2 to recover the recovery target (the target object PA in the present embodiment) (step S24).

Note that, in the above description, the information processing device 14 sets the recovery route R1 based on the position information of the mobile body 10A that has failed. However, the subject that performs this processing is not limited to the information processing device 14. For example, the mobile body 10B may acquire the position information of the mobile body 10A that has failed, and set the recovery route R1.

As described above, in the present embodiment, when the mobile body 10A fails, the mobile body 10B sets the recovery route R1 for recovering the recovery target based on the position information of the mobile body 10A that has failed. Accordingly, even when the mobile body 10A fails, the reduction in the operating ratio can be suppressed by causing another mobile body 10B to recover the recovery target. Further, in the present embodiment, the mobile body 10B recovers the target object PA conveyed by the mobile body 10A as the recovery target. Accordingly, interruption of the conveyance of the target object PA can be reduced.

### Second Embodiment

Next, a second embodiment will be described. The second embodiment differs from the first embodiment in that the mobile body 10A that has failed is a recovery target. That is, the recovery target may be the target object PA, or may be the mobile body 10A. In the second embodiment, the description of parts having the same configuration as those in the first embodiment will be omitted.

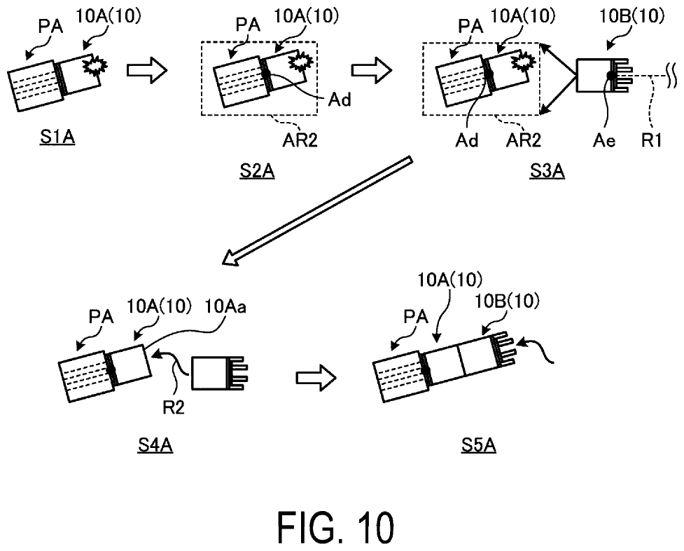

FIG. 10 is a schematic view illustrating a process of recovering a failed mobile body by another mobile body. In FIG. 10, an example is given in which a failure occurs in the mobile body 10A that is conveying a target object PA as illustrated in step S1A. However, the present embodiment is not limited thereto, and processing similar to the processing described below may be performed even when a failure occurs in the mobile body 10A that is not conveying a target object PA. In addition, the failure in the second embodiment is not limited to referring to a state in which movement is impossible, but a dropping of a target object PA is possible as in the case of the first embodiment. That is, the failure in the second embodiment may refer to a state in which movement is impossible, and dropping of a target object PA is also impossible.

The position information acquisition unit 64 of the information processing device 14 acquires the position information of the mobile body 10A that has failed. The position information acquisition unit 64 also acquires the position information of an area of interest AR2. The method of acquiring the position information of the mobile body 10A and the area of interest AR2 may be the same as that in the first embodiment.

The work setting unit 62 of the information processing device 14 sets a recovery route R1 for recovering a recovery target (mobile body 10A) by the mobile body 10B based on the position information of the mobile body 10A that has failed. The recovery route R1 is a route leading to the mobile body 10A, but is not limited to a route exactly reaching the position Ad of the mobile body 10A, and may be a route reaching a predetermined position Ae near the position Ad of the mobile body 10A. That is, the predetermined position Ae here is a position (waypoint) within a predetermined range from the position Ad of the mobile body 10A, but is not limited thereto, and may be the position Ad of the mobile body 10A. Further, in the second embodiment, the predetermined position Ae is preferably a position on a side on which the target object PA is not held with respect to the position Ad of the mobile body 10A (back side of the mobile body 10A on which the fork 24 is not disposed) so that the mobile body 10A can be recovered.

Specifically, the work setting unit 62 sets a first route from the initial position of the mobile body 10B to the predetermined position Ae, and a second route from the predetermined position Ae to a conveyance destination of the mobile body 10A as the recovery route R1. The conveyance destination of the mobile body 10A may be set arbitrarily, and may be any position that does not overlap with a route (the route used for conveyance) connecting waypoints A facing respective placement areas AR1, such as a waypoint A that is a charging point or a waiting point. The work setting unit 62 transmits information on the set recovery route R1 to the mobile body 10B. In the present embodiment, the work setting unit 62 also transmits information on the area of interest AR2 together with the information on the set recovery route R1 to the mobile body 10B.

### Recovery of Recovery Target

As illustrated in step S3A of FIG. 10, upon acquisition of the information on the recovery route R1, the movement control unit 82 causes the mobile body 10B to move along the recovery route R1 toward the mobile body 10A. When the mobile body 10B reaches within a predetermined distance range from the mobile body 10A (the predetermined position Ae in the present embodiment), the movement control unit 82 causes the sensor 26A to detect the position and the orientation of the recovery target (the mobile body 10A in the present embodiment). In the present embodiment, when the mobile body 10B reaches within the predetermined distance range from the mobile body 10A, the movement control unit 82 causes the sensor 26A to detect the area of interest AR2, that is, causes the sensor 26A to detect the area of interest AR2 as a detection area so as to detect the position and the orientation of the mobile body 10A. Then, as illustrated in step S4A of FIG. 10, the movement control unit 82 sets an approach route R2 to the mobile body 10A based on the position and the orientation of the mobile body 10A detected. The movement control unit 82 sets the approach route R2 that allows a predetermined position and a predetermined orientation with respect to the position and the orientation of the mobile body 10A detected (the position and the orientation at which the mobile body 10B can get coupled with the mobile body 10A). Note that, in the example of FIG. 10, the mobile body 10A is detected at the predetermined position Ae that is the arrival point of the first route of the recovery route R1, and a route from the predetermined position Ae to the mobile body 10A is set as an approach route, but the present embodiment is not limited thereto. For example, the movement control unit 82 may detect the mobile body 10A at any position on the recovery route R1 before reaching the predetermined position Ae, and set a route from the detection position to the mobile body 10A as the approach route R2.

As illustrated in step S5A of FIG. 10, the movement control unit 82 causes the mobile body 10B to move along the approach route R2 so as to approach the mobile body 10A, and thus causes the mobile body 10A to be coupled (connected) with the mobile body 10B. The method of coupling between the mobile body 10A and the mobile body 10B is arbitrary. For example, the mobile body 10B may be provided with a coupling mechanism for coupling with the mobile body 10A, and the mobile body 10B may control the coupling mechanism so as to get coupled with the mobile body 10A. Alternatively, for example, the movement control unit 82 may cause the mobile body 10B to approach the mobile body 10A by performing feedback control (direct feedback control) based on the detection result of the position and the orientation of the mobile body 10A and the detection result of the position and the orientation of the mobile body 10B. In that case, switching to the direct feedback control may be performed during the movement along the approach route R2. Also, coupling with the mobile body 10A may be made without using the approach route R2 as described above. In that case, for example, a marker may be attached to the mobile body 10A, the marker may be recognized by a camera of the mobile body 10B, and the mobile body 10B may approach the marker from the predetermined position Ae. Alternatively, for example, the coupling may be made by controlling the coupling mechanism of the mobile body 10B to extend so as to get coupled with the mobile body 10A while the mobile body 10B is kept at the predetermined position Ae.

When the mobile body 10B gets coupled with the mobile body 10A, the movement control unit 82 causes the mobile body 10B to move along the second route of the recovery route R1 so as to move (tow) the mobile body 10A to the conveyance destination.

As described above, in the second embodiment, the mobile body 10B recovers the mobile body 10A that has failed as the recovery target. Accordingly, interruption of the movement of other mobile bodies 10 due to the mobile body 10A can be reduced, and the operating ratio of the mobile bodies can be improved.

Note that, also in the second embodiment, the subject that performs the process of setting a recovery route R1 based on the position information of the mobile body 10A that has failed is not limited to the information processing device 14. For example, the mobile body 10B may acquire the position information of the mobile body 10A that has failed, and set the recovery route R1.

### Third Embodiment

The third embodiment differs from the second embodiment in that, when the mobile body 10A fails, a process of determining whether or not to recover a recovery target is performed. In the third embodiment, the description of parts having the same configuration as those in the second embodiment will be omitted. Note that the third embodiment can be also applied to the first embodiment. That is, in the third embodiment, the recovery target may be the mobile body 10A, or may be the target object PA.

In the third embodiment, the work setting unit 62 of the information processing device 14 acquires information on a scheduled work that is a work assigned to the mobile body 10. In the present embodiment, the work setting unit 62 acquires the information on scheduled works for mobile bodies 10 other than the mobile body 10A that has failed. The work of each mobile body 10 is set in advance by the work setting unit 62, and thus the work setting unit 62 acquires information about the works of the mobile bodies 10 scheduled after the current time as the information on the scheduled works.

The work setting unit 62 determines whether or not to recover the recovery target based on the information on the scheduled works for the mobile bodies 10. An example of the determination method will be described below.

For example, the work setting unit 62 determines to recover the recovery target if there is any mobile body 10 to which no scheduled work is assigned. Specifically, the work setting unit 62 selects a mobile body 10 to which no scheduled work is assigned as a recovery mobile body, and causes the mobile body 10 to recover the recovery target. That is, if there is a mobile body 10 to which no scheduled work is assigned (which has completed a work), the mobile body 10 is caused to recover the recovery target as the recovery mobile body. On the other hand, in the present example, if there is no mobile body 10 to which no scheduled work is assigned, the work setting unit 62 determines not to recover the recovery target. However, for example, the work setting unit 62 may acquire the information on the scheduled works for each predetermined time, and may determine for each predetermined time whether or not there is any mobile body 10 to which no scheduled work is assigned. Accordingly, even in a case where there is no mobile body 10 to which no scheduled work is assigned at a certain timing, upon appearance of a mobile body 10 that has completed a work after the certain timing and has no scheduled work assigned, the mobile body 10 may be selected as a recovery mobile body to recover the recovery target.

In addition, for example, the work setting unit 62 may determine whether or not to recover the recovery target based on whether or not it is possible to complete all the scheduled works while avoiding the recovery target. Completing the scheduled work while avoiding the recovery target means that the mobile body 10 can loads, conveys, and unloads the target object P while avoiding the recovery target (the mobile body 10A that has failed, or the target object PA). In the present embodiment, the work setting unit 62 determines that a scheduled work cannot be completed while the recovery target is avoided when the recovery target is located on the route R for the scheduled work, or determines that a scheduled work can be completed while the recovery target is avoided when the recovery target is not located on the route R for the scheduled work. Note that the route R for the scheduled work in this case is not limited to a route that was set before the failure of the mobile body 10A, and may be a route that has been reset so as not to pass through the position of the recovery target. That is, the work setting unit 62 determines that a scheduled work can be completed while the recovery target is avoided if a route starting from the initial position, passing through the first position of the scheduled work, and reaching the second position of the scheduled work can be set without passing through the position of the recovery target, or determines that a scheduled work cannot be completed while the recovery target is avoided if the above-described route cannot be set. The work setting unit 62 determines for every scheduled work whether or not the scheduled work can be completed while the recovery target is avoided.

Upon determining that all the scheduled works can be completed while the recovery target is avoided, the work setting unit 62 calculates a first total time and a second total time. The first total time is an estimated value of a total time required to complete all the scheduled works while recovering the recovery target. In other words, the first total time means a total value obtained by summing a total value of the estimated time from the start of a scheduled work until the end of the scheduled work for every scheduled work and an estimated time from when the mobile body 10 starts the recovery of the recovery target until when the recovery is completed. Further, in calculating the first total time, the work setting unit 62 calculates the estimated time from the start of a scheduled work to the end of the scheduled work on the assumption that the mobile body 10 can pass through the position of the recovery target. That is, the work setting unit 62 calculates the estimated time to complete a scheduled work based on the route for each scheduled work set on the assumption that the position of the recovery target is passable. On the other hand, the second total time is an estimated value of a total time required to complete all the scheduled works without recovering the recovery target. That is, the second total time means a total value of the estimated time from the start of a scheduled work until the end of the scheduled work for every scheduled work. Further, in calculating the second total time, the work setting unit 62 calculates the estimated time from the start of a scheduled work to the end of the scheduled work on the assumption that the mobile body 10 cannot pass through the position of the recovery target. That is, the work setting unit 62 calculates the estimated time to complete a scheduled work based on the route for each scheduled work set on the assumption that the position of the recovery target is impassable.

The work setting unit 62 determines to recover the recovery target when it is determined that all the scheduled works can be completed while the recovery target is avoided, and when the first total time is shorter than the second total time. On the other hand, the work setting unit 62 determines not to recover the recovery target when it is determined that all the scheduled works can be completed while the recovery target is avoided, and when the first total time is longer than the second total time. That is, when the first total time is shorter than the second total time, it is determined to recover the recovery target because the entire work time is shortened by recovering the recovery target. On the other hand, when the first total time is longer than the second total time, it is determined not to recover the recovery target because the entire work time is shortened by leaving the recovery target without recovering the recovery target. Note that when the first total time and the second total time are the same, it may be determined to recover, or not to recover the recovery target.

In addition, the work setting unit 62 determines to recover the recovery target when it is determined that not all the scheduled works can be completed while the recovery target is avoided, that is, when there is any scheduled work that cannot be completed while the recovery target is not recovered. In this case, the work setting unit 62 determines whether or not there are scheduled works that can be completed while the recovery target is avoided, and if there are scheduled works that can be completed while the recovery target is avoided, causes such scheduled works to be executed in sequence before the recovery target is recovered. Then, when a mobile body 10 having no scheduled work (mobile body 10 that has completed a work) appears during the execution of the scheduled works that can be completed while the recovery target is avoided, the mobile body 10 is caused to recover the recovery target as a recovery mobile body. In addition, for example, when all the scheduled works that can be completed while the recovery target is avoided are completed before a mobile body 10 having no scheduled work appears, a work for recovering the recovery target may be executed as the subsequent work, and then remaining scheduled works may be executed.

In the third embodiment, since it is determined whether or not to recover the recovery target as described above, the recovery target can be recovered while the reduction in work efficiency is suppressed, for example.

### Effects of the Disclosure

As described above, the information processing method according to the disclosure includes a step of acquiring position information of a mobile body 10A that has failed, and a step of setting a recovery route R1 based on the position information of the mobile body 10A that has failed, the recovery route R1 being a route leading to the mobile body 10A that has failed for recovering a recovery target by a recovery mobile body, the recovery mobile body being a mobile body 10 (mobile body 10B) other than the mobile body 10A that has failed. According to the disclosure, when the mobile body 10A fails, the mobile body 10B sets the recovery route R1 for recovering the recovery target based on the position information of the mobile body 10A that has failed. Therefore, even when the mobile body 10A fails, the reduction in the operating ratio can be suppressed by causing another mobile body 10B to recover the recovery target.

The information processing method according to the disclosure includes a step of causing a recovery mobile body (mobile body 10B) to move along a recovery route R1, a step of detecting position and orientation of a recovery target by the mobile body 10B when the mobile body 10B reaches within a predetermined distance range from the mobile body 10A, a step of setting an approach route R2 to the recovery target based on the position and the orientation of the recovery target, and a step of causing the mobile body 10B to move along the approach route R2 to recover the recovery target. According to the disclosure, even when the correct position of the recovery target is unknown due to the failure of the mobile body 10A, the mobile body 10B can appropriately approach the recovery target because the mobile body 10B detects the position and the orientation of the recovery target and sets the approach route R2.

The information processing method according to the disclosure further includes a step of setting an area of interest AR2 in which the recovery target is expected to be present based on the position information of the mobile body 10A that has failed, wherein, in the step of detecting the position and the orientation of the recovery target, the mobile body 10B is caused to detect the area of interest AR2. According to the disclosure, by setting the area of interest AR2, it is possible to cause the mobile body 10B to appropriately detect the recovery target and appropriately approach the recovery target.

The information processing method according to the disclosure further includes a step of acquiring information on scheduled works, each of the scheduled works being a work assigned a mobile body 10 other than the mobile body 10A that has failed, and a step of determining whether or not to recover the recovery target. By determining whether or not to recover the recovery target based on the scheduled works, the recovery target can be recovered while the reduction in work efficiency is suppressed, for example.

In the step of determining, if there is a mobile body 10 to which no scheduled work is assigned, the mobile body 10 is selected as a recovery mobile body and is caused to recover the recovery target. By causing the mobile body 10 to which no scheduled work is assigned to perform the recovery, the recovery target can be recovered while the delay in the scheduled works is reduced.

In the step of determining, it is determined to recover the recovery target when all the scheduled works can be completed while the recovery target is avoided, and when a first total time is shorter than a second total time, where the first total time is an estimated value of a total time required to complete all the scheduled works while recovering the recovery target, and the second total time is an estimated value of a total time required to complete all the scheduled works without recovering the recovery target. On the other hand, in the step of determining, it is determined not to recover the recovery target when all the scheduled works can be completed while the recovery target is avoided, and when the first total time is longer than the second total time. Accordingly, since it can be determined to recover the recovery target when the entire work time is shortened by recovering the recovery target, the recovery target can be recovered while the reduction in work efficiency is suppressed.

In the step of determining, it is determined to recover the recovery target when not all the scheduled works can be completed while the recovery target is avoided. Accordingly, the recovery target can be appropriately recovered.

The recovery target is a conveyance target (target object PA) conveyed by the mobile body 10A that has failed, or the mobile body 10A that has failed. According to the disclosure, the reduction in the operating ratio can be suppressed by recovering the target object PA or the mobile body 10A.

The embodiments of the disclosure have been described above, but the embodiment is not limited by the details of the embodiments above. Furthermore, the constituent elements of the above-described embodiments include elements that are able to be easily conceived by a person skilled in the art, and elements that are substantially the same, that is, elements of an equivalent scope. Furthermore, the constituent elements described above can be appropriately combined. Furthermore, it is possible to make various omissions, substitutions, and changes to the constituent elements within a range not departing from the scope of the above-described embodiments.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An information processing method comprising:
acquiring position information of a failed mobile body; and
setting a recovery route based on the position information of the failed mobile body, the recovery route being a route leading to the failed mobile body for recovering a recovery target by a recovery mobile body, the recovery mobile body being a mobile body other than the failed mobile body.

2. The information processing method according to claim 1, further comprising
causing the recovery mobile body to move along the recovery route,
detecting position and orientation of the recovery target by the recovery mobile body when the recovery mobile body reaches a position within a predetermined distance range from the failed mobile body,
setting an approach route to the recovery target based on the position and the orientation of the recovery target, and
causing the recovery mobile body to move along the approach route to recover the recovery target.

3. The information processing method according to claim 2, further comprising setting an area of interest in which the recovery target is expected to be present, based on the position information of the failed mobile body,
wherein, in the detecting the position and the orientation of the recovery target, the recovery mobile body is caused to detect the area of interest.

4. The information processing method according to claim 1, further comprising
acquiring information on a scheduled work, the scheduled work being a work assigned to a mobile body other than the failed mobile body, and
determining whether to recover the recovery target based on the information on the scheduled work.

5. The information processing method according to claim 4, wherein, in the determining, when there is a mobile body to which the scheduled work is not assigned, the mobile body is selected as the recovery mobile body and is caused to recover the recovery target.

6. The information processing method according to claim 4, wherein
in the determining,
it is determined to recover the recovery target when all of a plurality of the scheduled works can be completed while the recovery target is avoided, and when a first total time is shorter than a second total time, the first total time being an estimated value of a total time required to complete all of the plurality of the scheduled works while recovering the recovery target, and the second total time being an estimated value of a total time required to complete all of the plurality of the scheduled works without recovering the recovery target, and
it is determined not to recover the recovery target when all of a plurality of the scheduled works can be completed while the recovery target is avoided, and when the first total time is longer than the second total time.

7. The information processing method according to claim 4, wherein, in the determining, it is determined to recover the recovery target when not all of a plurality of the scheduled works can be completed while the recovery target is avoided.

8. The information processing method according to claim 1, wherein the recovery target is a conveyance target object to be conveyed by the failed mobile body.

9. The information processing method according to claim 1, wherein the recovery target is the failed mobile body.

10. An information processing device comprising:
a position information acquisition unit configured to acquire position information of a failed mobile body; and
a work setting unit configured to set a recovery route based on the position information of the failed mobile body, the recovery route being a route leading to the failed mobile body for recovering a recovery target by a recovery mobile body, the recovery mobile body being a mobile body other than the failed mobile body.

11. A non-transitory computer readable storage medium storing a program for causing a computer to perform processing, the processing comprising:
acquiring position information of a failed mobile body; and
setting a recovery route based on the position information of the failed mobile body, the recovery route being a route leading to the failed mobile body for recovering a recovery target by a recovery mobile body, the recovery mobile body being a mobile body other than the failed mobile body.
